(19) United States
(12) Patent Application Publication
(10) Pub. No.: US 2018/0005241 A1
(43) Pub. Date: Jan. 4, 2018

(54) REAL TIME VERIFICATION OF TRANSFERS OF FUNDS

(71) Applicants: Dean Elliott Smothers, Washington, DC (US); Dane Terrell Smothers, Capitol Heights, MD (US)

(72) Inventors: Dean Elliott Smothers, Washington, DC (US); Dane Terrell Smothers, Capitol Heights, MD (US)

(21) Appl. No.: 15/081,011

(22) Filed: Mar. 25, 2016

(51) Int. Cl. G06Q 20/40

(52) U.S. Cl. CPC G06Q 20/4016; G06Q 20/4014

(57) ABSTRACT

A computer-implemented method included receiving a first request to verify a first requested transfer of funds from a first account to a first merchant prior to the first merchant receiving an acceptance of the first requested transfer of funds; identifying a first instance of an application program installed on a first mobile wireless device as being associated with the first account; causing, in response to receiving the first request, a first notification of the first requested transfer of funds to be presented on the first mobile wireless device via the first instance of the application program; determining that the first requested transfer of funds is not approved by a user of the account based on a first message received from the first instance of the application program or a failure to receive a message from the first instance of the application program within a predetermined period of time; and causing use of the first account to be disabled in response to the determination that the first requested transfer of funds is not approved by a user of the account.

### BACKGROUND

Fraudulent or otherwise improper transactions of funds are a pressing concern, particularly in view of high profile releases of account information, such as credit card information, in recent years. Systems and methods that reduce the impact of inadvertent or hostile releases of account information are accordingly valuable.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates examples of features that may be included in a system for verifying transfers of funds or other transactions.

FIG. 2 illustrates an example of a graphical user interface (GUI) to manage accounts associated with a user and additional users associated with the accounts.

FIGS. 3A and 3B illustrate an example of a process for obtaining real time or near real time verification of transfers of funds.

FIG. 4A illustrates an example of a visual alert presented on a display unit included in a mobile wireless device.

FIG. 4B illustrates an example of a user prompt to verify a requested transfer of funds.

FIG. 5 illustrates an example of an alert presented on a mobile wireless device indicating that an account has been automatically disabled.

FIG. 6 illustrates a configuration in which the issuer system utilizes the verification system to obtain real time or near real time verification of a requested transfer of funds.

FIG. 7A illustrates a configuration in which the acquirer system utilizes the verification system, before contacting the issuer system, to obtain real time or near real time verification of a requested transfer of funds.

FIG. 7B illustrates a configuration in which the verification system replaces the acquirer system illustrated in FIG. 7A.

FIG. 8 illustrates a configuration in which a merchant system utilizes the verification system to obtain real time or near real time verification of a requested transfer of funds.

FIG. 9 is a block diagram that illustrates a computer system upon which aspects of this disclosure may be implemented.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

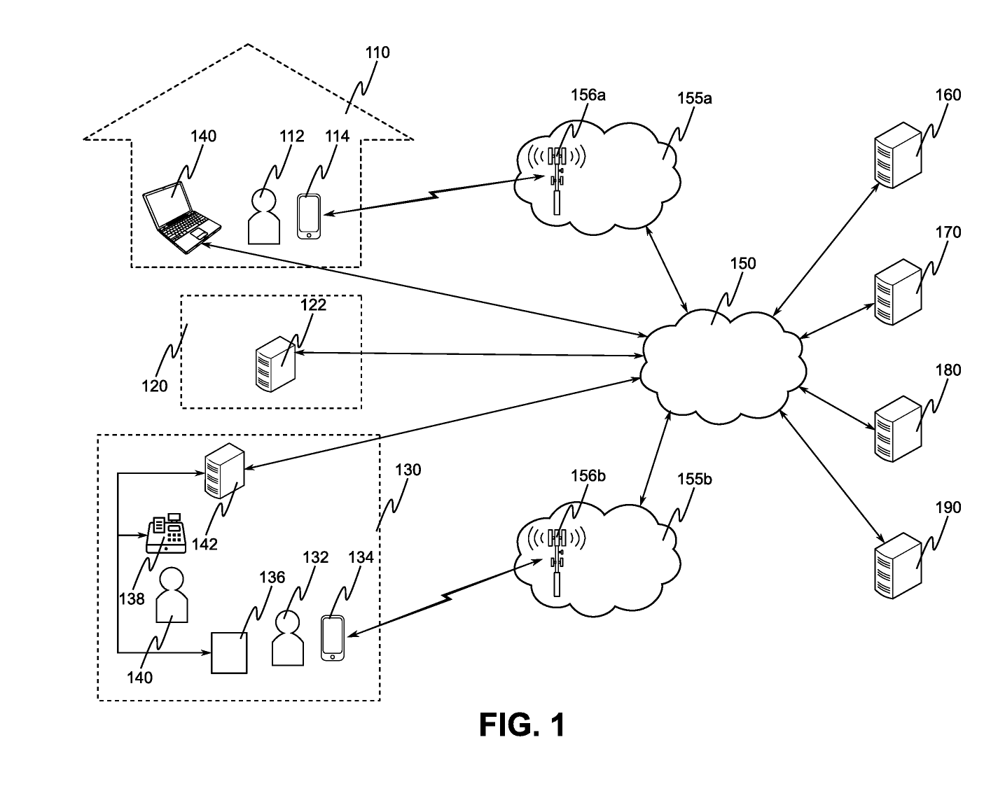

FIG. 1 illustrates examples of features that may be included in a system 100 for verifying transfers of funds or other transactions. Such transfers of funds may include, for example, use of a credit card, credit card account, or a debit card by a consumer for purchasing goods or services from a merchant. FIG. 1 illustrates a home 110, in which is located a consumer 112 (which may also be referred to as a “user,” such as a user of a mobile wireless device, a user of a program application executing on the mobile wireless device, or a user of a verification system that the program application interacts with), a mobile wireless device 114 associated with and used by the consumer 112, and a computer 116 used by the consumer 112. Examples of mobile wireless device 114 include, but are not limited to, smartphones (for example, Apple iPhone or iPad computing devices that utilize the iOS operating system, smartphones utilizing the Android operating system or derivatives thereof, smartphones utilizing Blackberry OS or derivatives thereof, and smartphones utilizing Microsoft Windows or Windows Mobile operating systems), tablet computers (for example, the Apple iPad series of tablet computers utilizing the iOS operating system, and tablet computers utilizing the Android operating system or derivatives thereof), notebook computers, laptop computers, smartwatches (for example, the Apple iWatch, smartwatches utilizing the Android Wear operating system, and the Pebble Watch), augmented reality units (for example, Microsoft HoloLens and Google Glass), and wearable computing devices. Mobile wireless device 114 may configured to, such as via a transceiver or modem included therein, to perform data communication via mobile wireless communication network 115a, such as a cellular data network, which may include communicating via wireless base station 156a. Mobile wireless device 114 may be configured to perform wireless data communication via other means, such as, but not limited to, 802.11 wireless, Bluetooth, and optical communication. Examples of computer 116 include, but are not limited to, a notebook computer, a laptop computer, a desktop computer, and a “smart TV.” Although one home 110 is illustrated in FIG. 1, in practice a plurality of homes would be involved with system 100, and there may be one or more consumers, one or more mobile wireless devices, and one or more computers within each home. Additionally, interactions of consumer 112 and mobile wireless device 114 are not limited to within home 110, but may also occur in other environments outside of home 110. The interaction of these elements with other elements illustrated in FIG. 1 will be described in more detail below.

FIG. 1 also illustrates two merchant locations: an online merchant location 120 and retail merchant location 130. A “retail merchant” may also be referred to as a “retailer.” A merchant operating via online merchant location 120 may provide goods and/or services for purchase via online merchant system 122, which may accessed by consumers, such as consumers 112 and 132, via wide area network 150. An example of wide area network 150 is the Internet, although other examples may be utilized, separately or in addition to the Internet. Online merchant system 122 may include, for example, one or more consumer-facing systems, which may execute software such as web server or other server programs configured to interact with software programs (such as a web browser application or an application configured to make purchases) executing on, for example, mobile wireless devices 114 and 134 and/or computer 116. The consumer-facing system might, for example, identify goods and/or services available for purchase, and/or allow a consumer to identify goods and/or services to be purchased. Online merchant system 122 may also include one or more payment transaction systems configured to obtain payment information, such as, but not limited to, credit card information, for purchases, and/or obtain authorization for purchases.

A non-limiting example of retail merchant location 130 is a retail store, such as, but not limited to, a convenience store, a grocery store, and a clothing store, Although a traditional “brick and mortar” store, in which a retailer maintains a physical building for sales, is an example of retail merchant location 130, retail merchant location 130 is not limited to such examples. For example, a merchant may not operate a storefront, but instead bring goods and/or services directly to a consumer, such as a repair services company or lawn care company. As another example, goods and/or services may be procured and/or received via telephone or other communications technologies.

At the particular retail merchant location 130 illustrated in FIG. 1, consumer 132, with an associated mobile wireless device 134, is making a purchase of goods and/or services. Mobile wireless device 134 may be configured much as described above for mobile wireless device 114. Mobile wireless device 134 may configured to, such as via a transceiver or modem included therein, to perform data communication via mobile wireless communication network 115b, such as a cellular data network, which may include communicating via wireless base station 156b. Consumer 132 may interact with a salesperson 140, who may be operating register system 138 for performing a transfer of funds from consumer 132 as payment for the goods and/or services. Examples of register system include, but are not limited to, a computerized cash register configured to receive credit card information, a portable credit card terminal, and a smartphone or tablet computer including a credit card reader device and accompanying software for performing credit card-based transfers of funds (for example, the hardware, mobile device-based software, and Internet infrastructure provided by Square Inc. for providing payment services to merchants). Alternatively or in addition, consumer 132 may interact with a payment terminal 136 in order to provide payment information for the goods and/or services. Examples of payment terminal include, but are not limited to, a self-service terminal at a grocery or convenience store, a credit card terminal integrated into a gas pump, and a fixed install credit card terminal configured to interact with register system 138. Payment terminal 136 and/or register system 138 may be configured to perform payment transactions via merchant system 142, which may be configured to, for example, interact with acquirer system 160 via wide area network 150 in order to perform authorization, capture, and/or settlement of credit card purchases, as well as other forms of payment. A plurality of register systems and/or payment terminals, whether at a single merchant location or across a plurality of merchant systems, may be configured to utilize retail merchant system 142. In some examples, payment terminal 136 and/or register system 138 may be configured to perform payment transactions directly with acquirer system 160.

Merchants discussed in this disclosure are not necessarily limited to those that may operate at an online merchant location or a retail merchant location. Given the dynamic and wide-ranging nature of commercial activities, there is a vast range of goods and services available, there are many ways for delivering goods and services, and there are many ways for merchants and consumers to conduct transactions. However, all merchants discussed in this disclosure are interested in performing transfers of funds from consumers, such as, but not limited to, by way of credit card accounts associated with consumers.

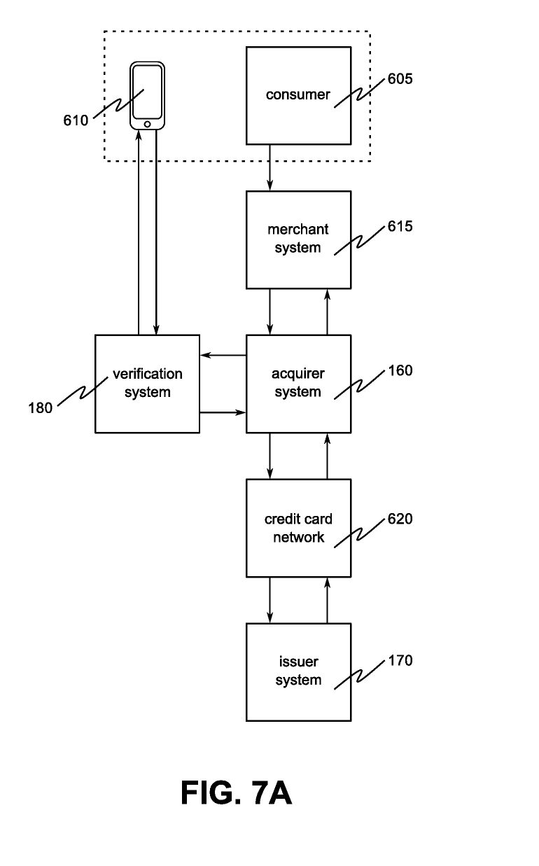

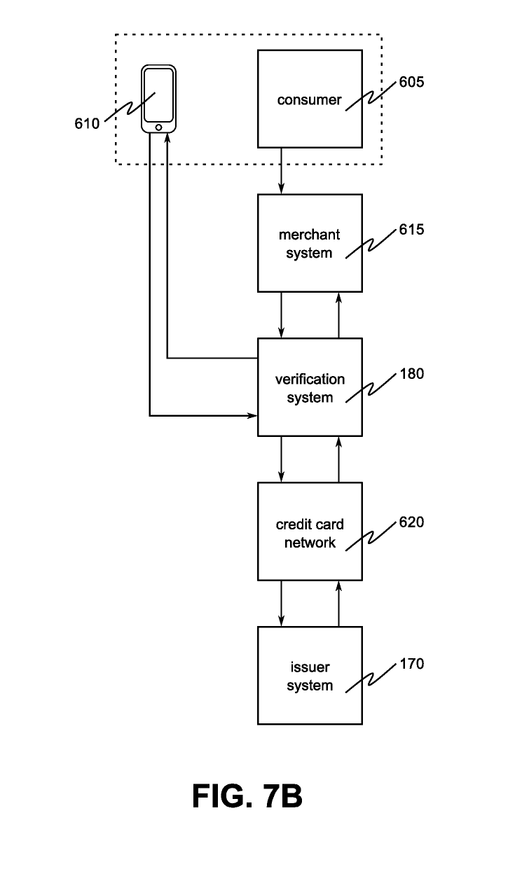

Acquirer system 160 (which may also be referred to as a “payment processor” or “payment processor system”) is a computer system involved in, for example, interacting with merchant systems, such as online merchant system 122 and retail merchant system 142, to perform credit card processing, including, for example, authorization of transfers of funds, capturing such transfers, clearing credit card transactions with issuers via a card network (not illustrated), providing transferred funds to merchant accounts. Although a single acquirer system 160 is illustrated in FIG. 1, there may be a plurality of different acquirer systems. For authorizing a transfer of funds via a credit card account, acquirer system 160 may be configured to receive from a merchant system details of a transaction and details of a credit card account via which funds are to be transferred to a merchant. In response to receiving such details, acquirer system 160 sends a request to an issuer system 170 associated with the credit card account to authorize the transaction. In response to this request, acquirer system 160 may receive a response from issuer system authorizing or denying the transaction, based on which acquirer system 160 provides a response to the merchant system requesting authorization of the transaction. As illustrated in FIGS. 7A and 7B, and discussed below, acquirer system 160 may be configured to interact with verification system 180 as part of authorizing credit card or other transactions.

Issuer system 170 is a computer system operated by or on behalf of a financial institution that issued a payment account to a consumer. Among other things, issuer system 170 is configured to perform authorization of transfers of funds. In response to a request for authorization of a transfer of funds, issuer system 170 my respond with an approval or rejection based on, for example, the amount of the transfer, previously requested transfers, and an available balance on an account from which funds are to be transferred from. Issuer system 170 may be configured to identify and reject fraudulent or potentially fraudulent transaction requests.

Verification system 180 is a computer system configured to, among other things, verify that an authorized user of an account has affirmatively approved, in real time or near real time, a transfer of funds from the account. As is discussed in greater detail below, verification system 180 is configured to interact with an instance or instances of one or more application programs installed on one or more mobile wireless devices, such as for obtaining approval for transfers of funds. In the particular example illustrated in FIG. 1, each of mobile wireless devices 114 and 134 has installed thereon an instance of one or more application programs configured for interacting with verification system 180. In some examples, there may be a plurality of application programs that verification system 180 is configured to interact with. For example, a first application program may be provided for devices utilizing the iOS operating system and a second application program may be provided for devices utilizing the Android operating system. As another example, an API (application programming interface) may be provided to facilitate including capabilities for interacting with verification system 180 into application programs. As part of a registration process, an instance of an application program installed on a mobile wireless device contacts verification system 180 and provides information identifying a user and/or an account, which results in verification system 180 recording an association between the instance of the application program with the provided user and/or account. Based on this association, verification system 180 is configured to identify instances of one or more application programs that have been associated with an identified account. For example, in response to use of a credit card account associated with consumer 132, verification system 180 may identify an instance of an application installed on mobile wireless device 134. Additional aspects of verification system 180 are discussed in greater detail below.

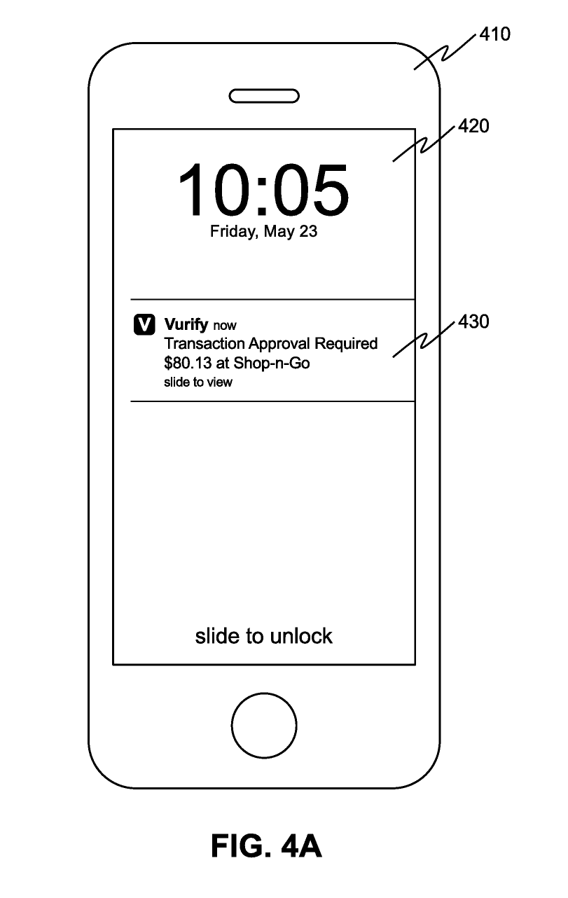

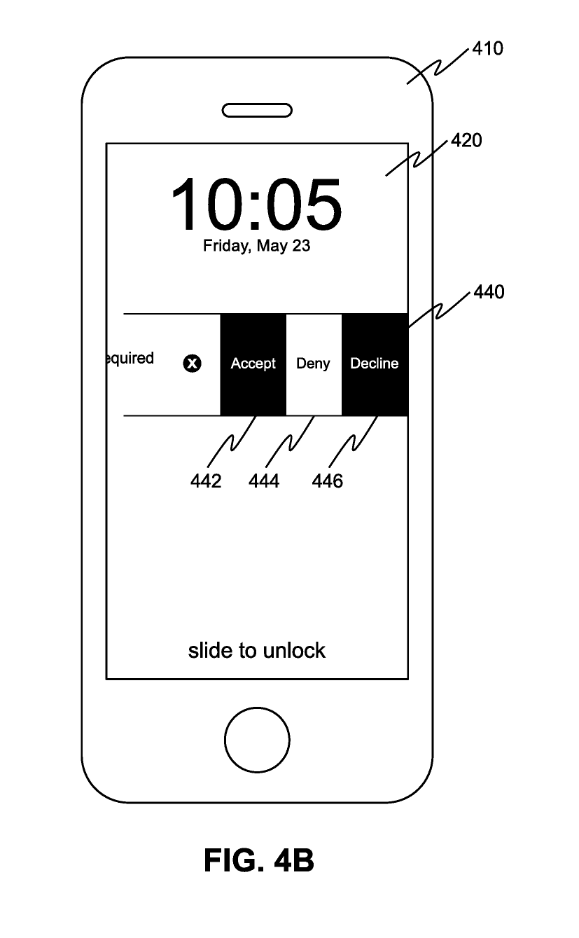

Notification system 190 is a computer system utilized for sending to notifications to mobile wireless devices, such as mobile wireless devices 114 and 134. Examples services involving notification system 190 include, but are not limited to, the Apple Push Notification Service (“APNs”) for delivering notifications to mobile wireless devices utilizing Apple's iOS operating system, and Google Cloud Messaging (“GCM”) for delivering notifications to mobile wireless devices utilizing Google's Android operating system. In order for verification system 180 to send notifications to mobile wireless device 114 via notification system 190, an instance of an application program installed and executing on the mobile wireless device requests a token from notification system 190, and the instance of the application program provides the token, along with information identifying the instance of the application program, to verification system 180. With the token, verification system 180 may request that a notification, with an accompanying payload, be delivered by notification system 190 to the instance of the application program installed on the mobile wireless device 114. Receipt of the notification by the instance of the application may result in an alert being presented via the mobile wireless device 114, such as displaying a message as illustrated in FIG. 4A.

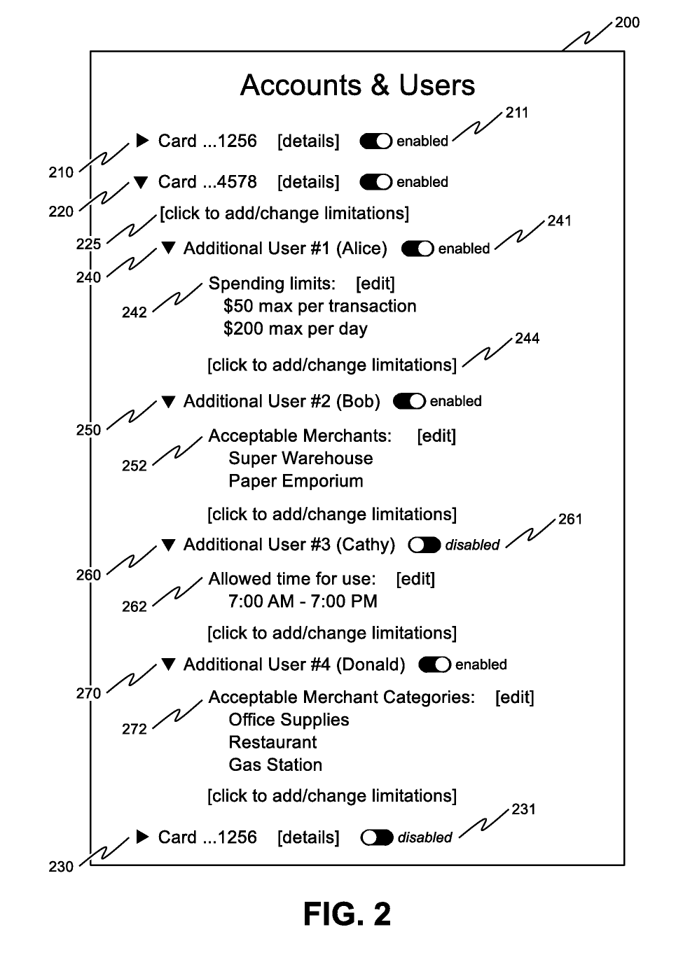

FIG. 2 illustrates an example of a graphical user interface (GUI) 200 to manage accounts associated with a user and additional users associated with the accounts. An application program installed on a mobile wireless device, such as mobile wireless device 114, or computer 116 may be configured to provide GUI 200 on a display unit included therein. The application program may be configured to interact with verification system 180 to obtain information about accounts, associated users, and limitations on use of accounts. The application program may be configured to control access to, or use of, GUI 200 based on a passcode, password, or biometric input. In some examples, GUI 200 may be displayed via a web browser application running on mobile wireless device 114 or computer 116, for example, using a web server provided by verification system 180. In such examples, the web browser may be viewed as displaying GUI 200 via the web browser application, or causing GUI 200 to be displayed via the web browser application. Access to information for a user or accounts associated with the user may be controlled by a username/password, and/or two-factor authentication, such as, but not limited to, confirmation via an application program instance associated with a user or account.

GUI 200 displays a listing of accounts associated with a user of installed instance of an application program. In the example illustrated in FIG. 2, three accounts are associated with a user, and information about the first, second, and third accounts is displayed in respective account display portions 210, 220, and 230 of GUI 200. Account display portion 210 includes a brief label for the first account (“Card . . . 1256”), an interface element that allows additional details to be displayed for the first account, and account enable/disable interface element 211. Selection of the interface element that allows additional details to be displayed for the first account may cause a new GUI to be displayed in place of GUI 200, or additional elements to be displayed in GUI 200 to provide access to the additional details about the selected account, such as, but not limited to, identification of a financial institution associated with the account, contact information for the financial institution, an account identifier (such as, but not limited to, a credit card number for a credit card account), an account balance, a credit limit, and/or a remaining amount of credit. Account enable/disable interface element 211 may be used to selectively enable or disable its respective first account. In the example illustrated in FIG. 2, the first and second accounts are enabled, and the third account is disabled (as shown by account enable/disable interface element 231). Verification system 180 may be configured to record whether the first account has been enabled or disabled in response to use of account enable/disable interface element 211. Verification system 180 may be configured to enable or disable an account in response to information received from an issuer for the account. Verification system 180 may be configured to indicate to another system, such as issuer system 170, that the first account should be enabled or disabled. Account enable/disable interface element 211 may be used to reenable an account that was automatically disabled by verification system 180 in response to receiving a request to verify a transfer. In some implementations, account enable/disable interface element 211 may only be used to reenable an account within a predetermined period of time after the account was automatically disabled; and after the predetermined period of time has elapsed it will be necessary to contact an issuer for the account or other service provider.

In the example illustrated in FIG. 2, an arrow is provided on the left hand side of each of account display portions 210, 220, and 230 to selectively display limitations and/or additional users associated with an account. Such information is displayed for the second account in account display portion 220, whereas although limitations and/or additional users may be associated with the first and/or third accounts, GUI 200 has not been arranged to display such information.

In some examples, verification system 180 may be configured to allow multiple users or instances of application programs to be associated with an account. In the particular example illustrated in FIG. 2, a total of five users are associated with the second account: the user for whom GUI 200 is being displayed, and four additional users: additional user #1 for whom details are displayed in user display portion 240, additional user #2 for whom details are displayed in user display portion 250, additional user #3 for whom details are displayed in user display portion 260, and additional user #4 for whom details are displayed in user display portion 270. User enable/disable interface element 241 may be used to selectively enable or disable its respective user, and user enable/disable interface elements are included in each of user display portions 240, 250, 260, and 270, with user enable/disable interface element 261 set to disable additional user #3.

For each user, zero or more user-level limitations on use of an account may be recorded by verification system 180. In some examples, zero or more account-level limitations of use of an account may be recorded, which are applied to all requested transfers regardless of the user involved. These limitations may be displayed, added, removed, and/or modified via GUI 200. Examples of such limitations include, but are not limited to, spending limits (see limitation display portion 242), which may be per transaction (a limit of $50 per transaction is illustrated) or per day (a limit of $200 per day is illustrated); whitelisted merchants (see limitation display portion 252, in which additional user #2 is only permitted to make purchases from Super Warehouse and Paper Emporium); blacklisted merchants (identifying merchants for which requests will be denied); whitelisted merchant types/categories (see limitation display portion 272); blacklisted merchant types (for example, denying requests for merchants selling guns, tobacco, or alcohol); whitelisted types/categories of goods and/or services; blacklisted types/categories of goods and/or services; geographic limitations on merchant locations (whitelisted and/or blacklisted); geographic limitations on shipment destinations (including specification of specific addresses); geographic limitations on a location of a mobile wireless device at the time of a transaction (including, for example, the actual location of the mobile wireless device or a distance from the merchant); limitations on allowed times and/or days of use (see limitation display portion 262), which may be whitelisted or blacklisted times and/or days; and a requirement that biometric information be captured (for example, via a mobile wireless device or a device operated by a merchant).

In another graphical user interface (not illustrated), which may also be displayed via mobile wireless device 112 or computer 116, for example, a listing of requested transfers may be displayed. Using this GUI, a user may identify a selected transfer as a reoccurring charge, and may set limitations for the reoccurring charge, such as, but not limited to, a maximum transfer amount or on timing between occurrences (such as, for example, only once per calendar month, of a minimum period of 3 weeks between occurrences). Verification system 180 may record a specification of the reoccurring charge, such as an identification of the merchant and limitations to be applied, in association with an account and automatically accept future requested transfers requested by the same merchant, so long as they meet any specified (or implied) limitations on the reoccurring transaction (see the discussion of 310 below for more details).

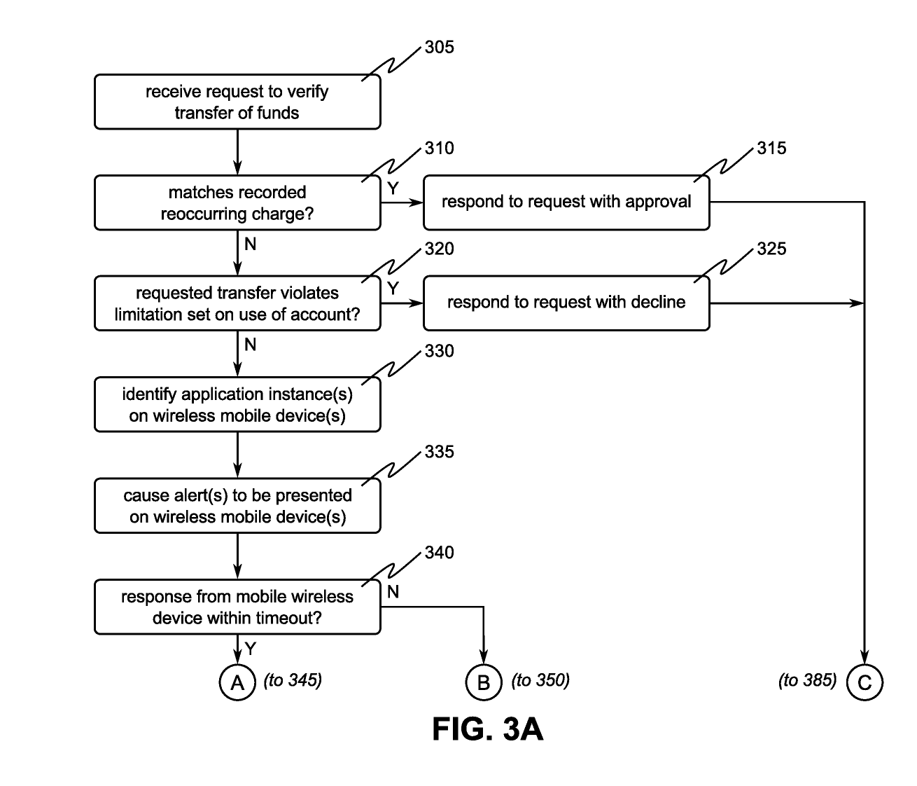

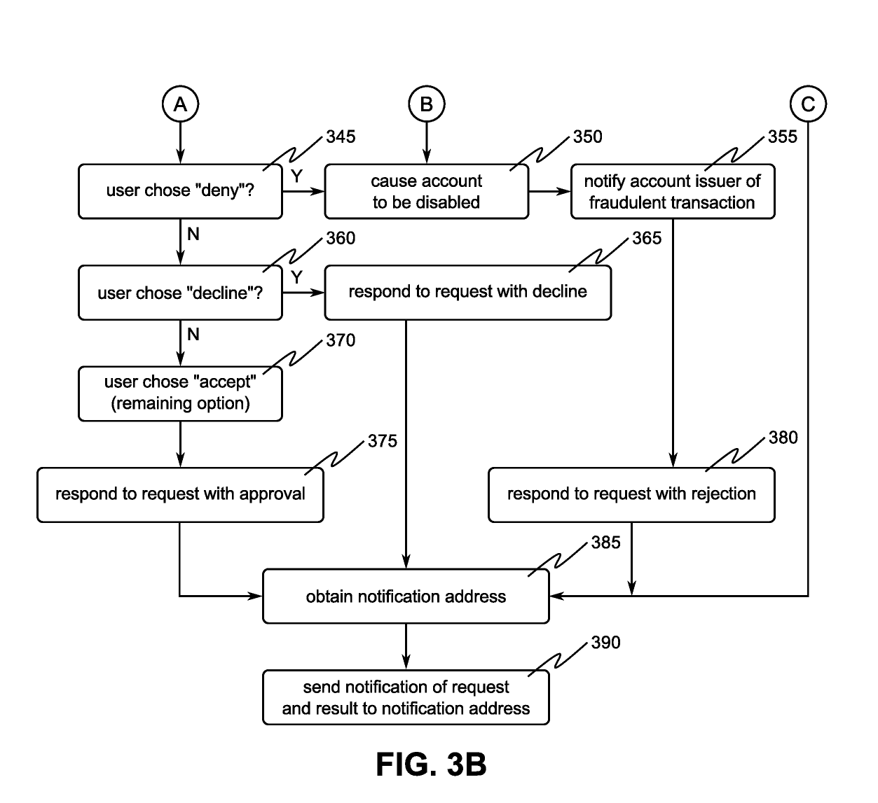

FIGS. 3A and 3B illustrate an example of a process for obtaining real time or near real time verification of transfers of funds. It is noted that this disclosure is not limited to the particular arrangement or order of operations illustrated in FIGS. 3A and 3B. Verification system 180 may be configured to perform some or all of the aspects of the procedure illustrated in FIGS. 3A and 3B. At 305, verification system 180 receives a request to verify a requested transfer of funds from an account to a merchant. The request may be received in response to, for example, an authorization request for use of a credit card account issued by a merchant system. The request is received by verification system 180 prior to the merchant receiving an automated acceptance of the requested transfer of funds, which allows an authorized user of the account to perform real time or near real time verification of the requested transfer before providing the merchant with approval for the requested transfer. The request may provide, or verification system 180 may otherwise obtain, for example, an amount of the requested transfer of funds, an identifier for the account (for example, a credit card number for a credit card account), an identifier for the merchant (for example, a name of the merchant), an address or other location information for the merchant, and/or information about goods and/or services associated with the transfer. Verification system 180 is configured to identify, in response to the request received at 305, the account from which funds are to be transferred out of. In some examples, verification system 180 may be configured to determine whether the identified account is enabled or disabled, based on information recorded by verification system 180 and/or obtained from another system. Although not illustrated in FIGS. 3A and 3B, in response to the request received at 305, verification system 180 may respond to the request with a decline or rejection of the request if it is determined that the identified account is not enabled.

At 310, verification system 180 determines whether the transfer of funds matches a reoccurring charge recorded in verification system 180 in association with the identified account. The determination whether the transfer of funds matches a specification of a reoccurring charge may be based on an identification of a merchant for the transfer corresponds to a merchant for a recorded reoccurring charge. The determination whether the transfer of funds matches a reoccurring charge may additionally be based on whether an amount of the requested transfer is less than or equal to a maximum transaction amount recorded for the reoccurring charge. The determination whether the transfer of funds matches a reoccurring charge may additionally be based on whether a minimum period of time recorded for the reoccurring charge has elapsed since the last occurrence of the reoccurring charge (for example, the reoccurring charge may not occur more frequently than once a calendar month, or no more frequently than every 3 weeks).

If at 310 the requested transaction matches a reoccurring charge recorded in verification system 180 (‘Y’), the process continues at 315; otherwise (‘N’), the process continues at 320. At 315, verification system 180 responds to the request received at 305 with an approval of the request. In some examples, verification system 180 may be configured to record when the reoccurring charge occurred, and this information may be used to ensure that the same reoccurring charge does not reoccur too soon. In some examples, if a merchant for the requested transfer corresponds to a merchant for a recorded reoccurring charge, but other aspects of the requested transfer violate limitations recorded for the reoccurring charge (such as a maximum transaction amount or a minimum amount of time between reoccurring charges to a single merchant), an alert presented at 325 may expressly indicate that the requested transfer violated a limitation for a reoccurring charge, to provide an indication to a user that there may be an issue to be resolved with the merchant.

As discussed with respect to FIG. 2, one or more users, and associated installed instances of one or more application programs, may be associated with each account (although in some examples, only a single user may be associated with each account). Verification system may be configured to, before 310, determine whether more than one user is associated with the identified account, and in response to more than one user being associated with the identified account, identify which user is believed to be using the account for the request received at 305. In response to the identified user being disabled with respect to the account, verification system 180 may respond to the request received at 205 with a decline or rejection of the request.

There are various techniques by which verification system 180 may identify which user is believed to be using the account. In some examples, verification system 180 may identify the user based on geographic proximity to the merchant, with geographic locations of users obtained via their respective wireless mobile devices. In some examples, verification system 180 may by default treat an account with multiple users as disabled, and allow an individual user, via their respective wireless mobile device, to indicate shortly before the request at 305 is received, that the user intends to initiate a transfer. As a result, verification system 180 may treat the account as enabled for the next incoming request to transfer funds from the account, if the next incoming request is received within a predetermined amount of time, such as five minutes. In some examples, request 305 may result in all enabled users being notified at 325, and a “accept” received from one of the users treated as use of the account by that user (which would also result in at least a portion of 320 being performed after the response is received from the identified user.

At 320, verification system 180 determines whether the requested transfer of funds violates any limitations set on use of the account. As discussed above with respect to FIG. 2, zero or more limitations may be recorded in association with an account (account-level limitations) and/or a user associated with an account (user-level limitations). If one or more account-level limitations are recorded, verification system 180 obtains information regarding the request received at 305 to determine whether any of the account-level limitations are violated. This information may be obtained from data included with the request, may be determined based on information included in one or more databases included in or accessible by verification system 180 (for example, a merchant name or merchant identifier included in a request may be used to identify a merchant type/category), may be obtained from another system (such as, but not limited to, acquirer system 160 or issuer system 170, and/or may be obtained via an instance of an application program installed on a mobile wireless device (for example, verification system 180 may request location information or that biometric information, such as a fingerprint, be captured). In some examples, if information is not available to access whether a particular limitation has been violated (for example, a merchant type/category may not be able to be determined), that limitation might be ignored. User-level limitations are handled in much the same manner, once a user has been identified. If at 320 it is determined that an account-level or user-level limitation has been violated (‘Y’) the process proceeds to 325, otherwise (‘N’) the process proceeds to 330. At 325, verification system 180 responds to the request received at 305 with a decline. This may result in the merchant receiving an indication that the transfer has been declined.

At 330, verification system 180 identifies one or more instances of one or more application programs installed on one or more mobile wireless devices. Verification system 180 maintains a database that associates instances of application programs with accounts. The database is updated as part of registration/deregistration procedures performed between an instance of an application program and verification system 180. For example, on first running an installed instance of an application program (including during an installation or setup of the application program), the instance of the application program might register itself with verification system 180 as being associated with one or more accounts. As another example, an application program may be configured to allow adding an account, in response to which the application program may register itself with verification system 180 as being associated with the added account. Deregistration might occur, for example, as part of an account removal process provided by an application or an uninstall procedure implemented by an application. If multiple users (and associated instances of one or more application programs) are associated with the identified account, and a particular user has been identified for the request received at 305, an instance associated with the user may be identified. In some examples, a plurality of instances may be identified, such as where a user has installed appropriate application programs on multiple mobile wireless devices, or where a single user has not been selected from a plurality of enabled users associated with an account (in which case, all of the enabled users, and their associated instances, may be identified). An identification of an instance may comprise a token for transmitting a notification via notification system 190.

At 335, verification system 180 causes alert(s) to be presented via the application instance(s) identified at 330. For example, verification system 180 may be configured to, for each instance identified at 330, utilize notification system 190 to send a notification to the instance. The notification may include a data payload providing the receiving instance with details about the request received at 305; for example, the data payload may include a transaction amount and/or a merchant identifier (such as, but not limited to, a merchant name and/or location). In some examples, an application program may be configured to request additional information from verification system 180 in response to receiving a notification, or in response to a user inquiry for additional information.

In response to receiving a notification about the request received at 305, an instance of an application program presents an alert via the mobile wireless device on which the instance is installed. Thus, by having sent the notification, which in turn results in an alert having been displayed, verification system 180 causes the alert to be presented via the mobile wireless device. Examples of the alert include, but are not limited to, a visual alert on a display unit included in the mobile wireless device, an audible alert (such as a sound played through a speaker included the mobile wireless device), a vibratory alert, and a haptic alert. FIG. 4A illustrates an example of a visual alert 430 presented on a display unit 420 included in a mobile wireless device 410. In the particular example illustrated in FIG. 4A, visual alert 430 is displayed despite the mobile wireless device 410 being “locked.” This allows the alert to be presented more quickly to a user of mobile wireless device 410. The application program causing visual alert 430 to be displayed may be configured to respond to user interaction visual alert 430 by displaying a user prompt regarding the request received at 305. FIG. 4B illustrates an example of a user prompt 440 to verify a requested transfer of funds. In this particular example, by sliding visual alert 430 to the left, user prompt 440 is displayed on the display unit 420. User prompt 440 presents three options to the user: accept button 442, deny button 444, and decline button 446. In some examples, user prompt 440 may not include decline button 446.

Selection of accept button 442 is intended to provide an express indication that the request received at 305 has been accepted (or approved) by an authorized user of the identified account. The application program may be configured to prompt a user to enter a pin, passcode, password, or provide biometric input in response to accept button 442 being selected. In some examples, the pin, passcode, password, biometric input, or data derived therefrom (such as, but not limited to, a hash) may be transmitted in a message to verification system 180 for validation, along with an indication that accept button 442 was selected. In some examples, the application program may validate the pin, passcode, password, or biometric input, and in response to it being valid, transmit a message to verification system 180 indicating that accept button 442 was selected. In some examples, the application program may not prompt for a pin, passcode, password, or biometric input in response to a determination that similar information was recently submitted, such as to “unlock” mobile wireless device 410 from a “locked” state.

Selection of deny button 444 is intended to provide an express indication that the request received at 305 has been rejected (or not approved) by an authorized user of the identified account. As is discussed in more detail below, selection of deny button 444 will prompt verification system 180 to disable the identified account, and may also notify an account issuer that the request at 305 was fraudulent. In view of such consequences, the user may be asked to confirm selection of deny button 444 to avoid the user inadvertently disabling the identified account. Selection of decline button 446 is intended to provide a mechanism for effectively cancelling a transfer without the consequences that may occur in connection with selecting deny button 444 (for example, disabling the identified account and/or notifying an account issuer of fraudulent activity).

The application program may be configured such that by sliding visual alert 430 to the right, a user can review more detailed information about the requested transfer of funds. This may require, in some examples, the user to enter a pin, passcode, password, or biometric input in order to “unlock” mobile wireless device 410 or to access a detailed information display mode of the application program. The detailed information display mode might display, for example, a listing of goods and/or services associated with the requested transfer, and/or a map showing a location of the merchant requesting the transfer.

At 340, verification system 180 determines whether a response message indicating express selection of one of the “accept,” “deny,” or “decline” options is received from a notified instance within a timeout period. In some examples, the timeout period is brief: for example, 5, 10, 15, 20, 25, 30, 40, 50, or 60 seconds, which assists verification system 180 in providing a real time or near real time response to the request received at 305. In some examples, the timeout period may be extended in response to an indication received from an instance that a user is interacting with the instance or the mobile wireless device the instance is installed on. For example, it may be helpful to provide a user with additional time to enter a pin, passcode, password, or biometric input, or to review details of the requested transfer of funds. In some implementations, an instance of an application program may display a numeric and/or graphical (for example, a bar graph) countdown timer on the mobile wireless device on which it is installed, to indicate to a user that a limited time is allowed to respond. If a response is not received within the timeout period (‘N’), the process continues to 350 (via node B linking FIGS. 3A and 3B). Thus, as a result of a failure to receive an allow, deny, or decline message within the timeout period, verification system 180 determines that the requested transfer of funds is not approved by an authorized user of the identified account. If a response is received from the instance before the timeout period expires (‘Y’), the process continues to 345 (via node A linking FIGS. 3A and 3B).

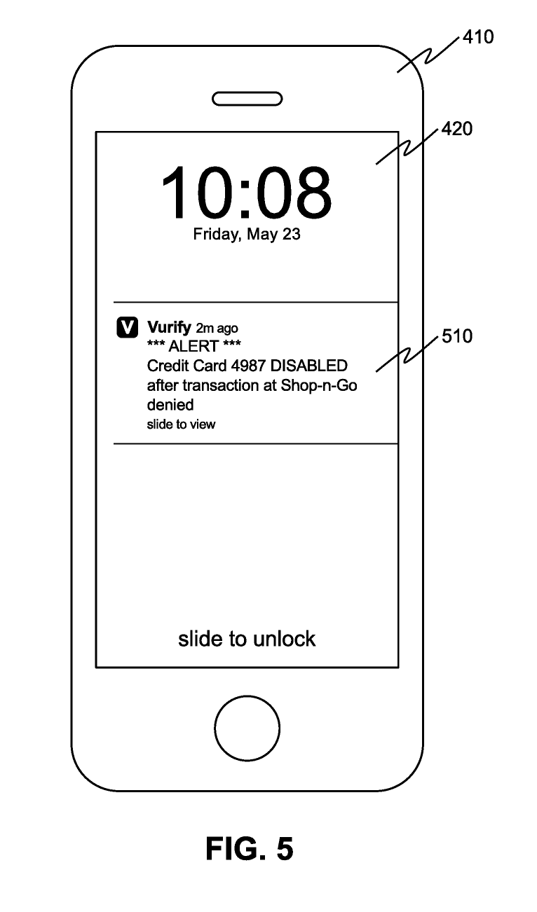

At 345, in response to receiving the message at 340, and based on the received message, verification system 180 determines whether the user chose the “deny” option (for example, by selecting deny button 444 illustrated in FIG. 4B). If not (‘N’), the process continues to 360. Is so (‘Y’), the process continues to 350. At 350, verification system 180 causes the identified account to be disabled. For example, verification system 180 may record, in a database included in verification system 180 or otherwise accessible by verification system 180, that the identified account is disabled or not enabled. As another example, verification system 180 may send a message or other notification to another system, such as, but not limited to acquirer system 160 or issuer system 170, that causes the receiving system to disable the identified account. In some examples, verification system 180 may be configured to cause an alert to be presented on one or more mobile wireless devices associated with the identified account (via, for example, an instance of a program application installed on the mobile wireless device) indicating that the account was been disabled. For example, verification system 180 may be configured to send notifications, via notification system 190, to one or more application program instances associated with the identified account that the identified account was disabled, and a receiving instance may be configured to present an alert on the mobile wireless device on which it is installed in response to the notification. FIG. 5 illustrates an example of an alert 510 presented on a mobile wireless device indicating that an account has been automatically disabled. Much as discussed previously, in some examples, a user may reenable the disabled account via an instance of an application program installed on mobile wireless device 410, although a limited period of time may be allowed to reenable via the application program in some implementations.

At 355, verification system 180 may be configured to notify an issuer system associated with the identified account that the requested transfer of funds is fraudulent. This notification may cause the receiving issuer to disable the identified account, investigate the requested transfer, and/or take other action. At 380, verification system 180 responds to the request received at 305 with a rejection of the request. In some examples, there is no difference between a decline (such as at 325 and 365) and a rejection (such as at 380). In other examples, a rejection may be indicated differently by verification system 180 to a system that issued the request received at 305, and this difference, or another difference, may be indicated to the requesting merchant versus a decline.

At 360, in response to receiving the message at 340, and based on the received message, verification system 180 determines whether the user chose the “decline” option (for example, by selecting decline button 446 illustrated in FIG. 4B). If not (‘N’), the process continues to 370. Is so (‘Y’), the process continues to 365. At 365, verification system 180 responds to the request received at 305 with a decline of the request.

At 370, in response to receiving the message to 340, verification system 180 determines that the user chose the “accept” option (for example, by selecting accept button 442 illustrated in FIG. 4B). This determination may be based on the received message, or based on the message being neither for the “deny” or “decline” options. At 375, verification system 180 responds to the request received at 305 with an approval of the request. From each of 315 (via node C linking FIGS. 3A and 3B), 325 (via node C linking FIGS. 3A and 3B), 375, and 380, the process illustrated in FIGS. 3A and 3B continues at 385.

At 385, verification system 180 obtains a notification address, such as, but not limited to, an email address or a text messaging number or address, for the identified account. The notification address may be recorded by verification system 180 as part of a registration process in connection with the identified account. At 390, verification system 180 sends a notification, such as, but not limited to, an email or text message, of the request received at 305 and a result of verification system 180 handling the request (for example, whether the request was accepted, denied, declined, or timed out, or if the account was disabled). This notification may be sent immediately after verification system 180 responds to the request received at 305. Verification system 180 may be configured to send other notifications to the notification address; for example, in response to a disabled account being reenabled.

In some examples, verification system 180 may be configured to allow a user to temporarily transfer their ability to interact with verification system 180 to another mobile wireless device or a computer-based terminal. This may be useful in the event that the user experiences a battery, device, or other failure with the mobile wireless device ordinarily used by the user. For example, after authenticating with verification system 180, the user may obtain a temporary code from verification system 180 that may be provided to an instance of an application program installed on another mobile wireless device or computer-based terminal. Using the temporary code, the instance of the application program may temporarily, such as for a single transfer of funds, become associated with the user or a particular account associated with the user. In some implementations, the application program may be configured to allow the user to authenticate with verification system 180 and associate an instance of the application program with the user or the account associated with the user without an intermediate step of the user obtaining and providing a temporary code. In some examples, a user may be provided in advance with one or more single use temporary codes, such as on a card that may be kept in a purse or a wallet, that may be used in connection with a pin, passcode, passphrase, or biometric input provided by the user.

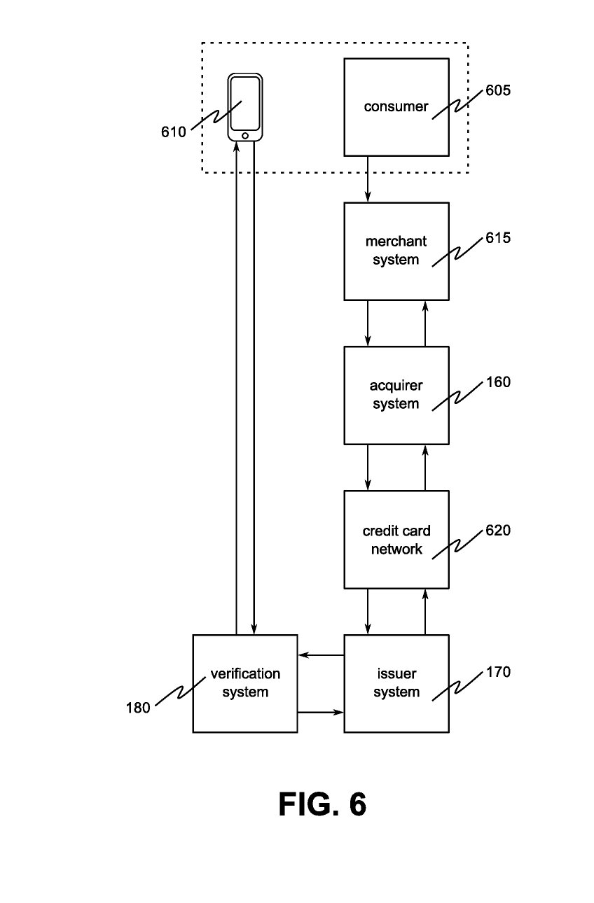

FIG. 6 illustrates a configuration in which the issuer system utilizes the verification system 180 to obtain real time or near real time verification of a requested transfer of funds. Consumer 605, who is also in possession of mobile wireless device 610, initiates a transaction with a merchant that operates merchant system 615. Examples of mobile wireless device 610 include mobile wireless devices 114 and 134. Examples of merchant system 615 include online merchant system 122 and retail merchant system 142. Merchant system 615 requests authorization of a transfer of funds via acquirer system 160. Acquirer system 160, via credit card network 620, requests issuer system 170 to authorize the transfer of funds. Issuer system 170, in the example illustrated in FIG. 6, transmits a request to verification system 180 to obtain real time or near real time verification of a requested transfer of funds. Much as discussed with respect to FIGS. 3A and 3B, verification system 180 interacts with mobile wireless device 610 and an instance of an application installed thereon to obtain an express or implied (in the event of an expiration of a time period for a reply from mobile wireless device 610 to verification system 170) indication of whether user 605 accepts, denies, or declines the transfer of funds.

FIG. 7A illustrates a configuration in which the acquirer system utilizes the verification system, before contacting the issuer system, to obtain real time or near real time verification of a requested transfer of funds. Consumer 605, merchant system 615, acquirer system 160, credit network 620, and issuer system 170 interact with each other much in the same way discussed with respect to FIG. 6. However, in this example it is acquirer system 160, rather than issuer system 170, that interacts with verification system 180. Acquirer system 160 may be configured to contact verification system 180 either prior to or after contacting issuer system 170. FIG. 7B illustrates a configuration in which the verification system replaces the acquirer system illustrated in FIG. 7A.

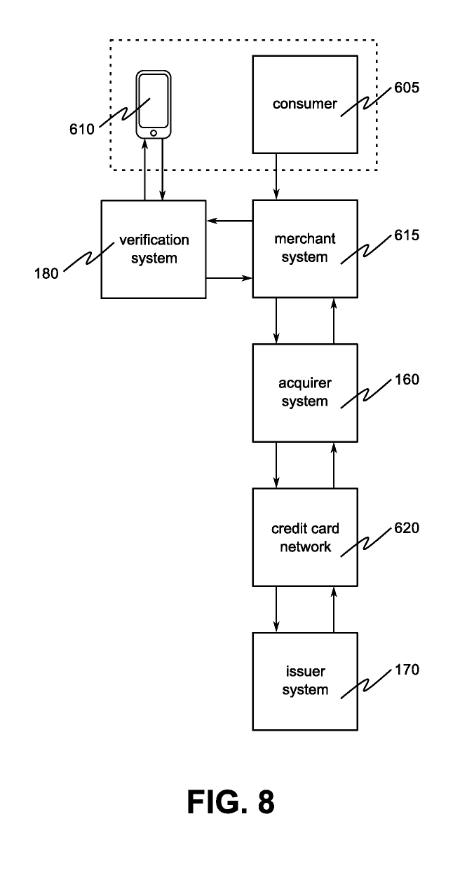

FIG. 8 illustrates a configuration in which a merchant system utilizes the verification system to obtain real time or near real time verification of a requested transfer of funds. Consumer 605, merchant system 615, acquirer system 160, credit network 620, and issuer system 170 interact with each other much in the same way discussed with respect to FIG. 6. However, in this example it is merchant system 615, rather than issuer system 170, that interacts with verification system 180. This interaction occurs prior to merchant system 615 contacting acquirer system 160 regarding the transfer of funds.

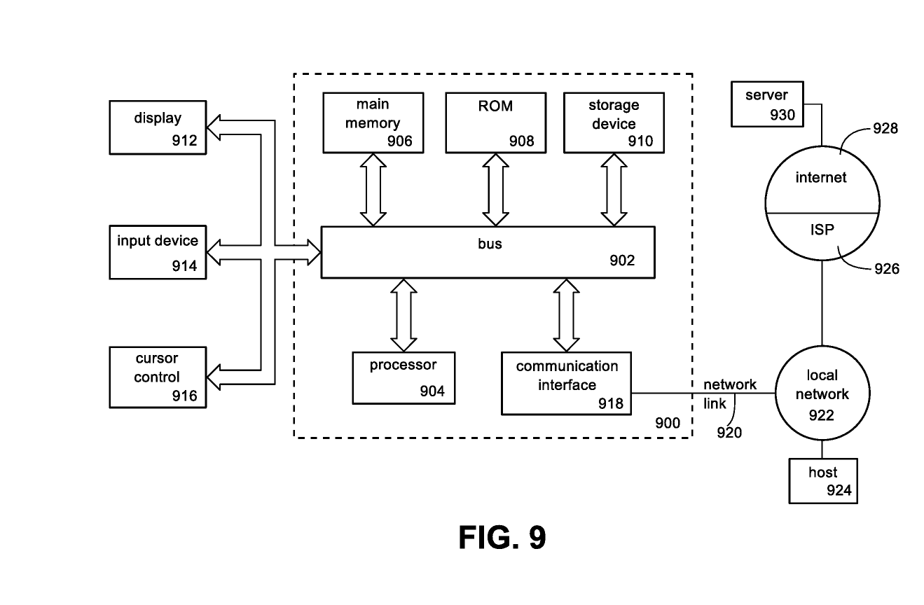

FIG. 9 is a block diagram that illustrates a computer system 900 upon which aspects of this disclosure may be implemented, such as, but not limited to mobile wireless devices 114 and 134, computer 116, online merchant system 122, payment terminal 136, register system 138, retail merchant system 142, acquirer system 160, issuer system 170, verification system 180, and notification system 190. Computer system 900 includes a bus 902 or other communication mechanism for communicating information, and a processor 904 coupled with bus 902 for processing information. Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT) or liquid crystal display (LCD), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane. Another type of user input device is a touchscreen, which generally combines display 912 with hardware that registers touches upon display 912.

This disclosure is related to the use of computer systems such as computer system 900 for implementing the techniques described herein. In some examples, those techniques are performed by computer system 900 in response to processor 904 executing one or more sequences of one or more instructions contained in main memory 906. Such instructions may be read into main memory 906 from another machine-readable medium, such as storage device 910. Execution of the sequences of instructions contained in main memory 906 causes processor 904 to perform the process steps described herein. In some examples, hard-wired circuitry may be used in place of or in combination with software instructions to implement the various aspects of this disclosure. Thus, implementations are not limited to any specific combination of hardware circuitry and software.

The term “machine-readable medium” as used herein refers to any medium that participates in providing data that causes a machine to operation in a specific fashion. In some examples implemented using computer system 900, various machine-readable media are involved, for example, in providing instructions to processor 904 for execution. Such a medium may take many forms, including but not limited to, non-volatile media, volatile media, and transmission media. Non-volatile media includes, for example, optical or magnetic disks, such as storage device 910. Volatile media includes dynamic memory, such as main memory 906. Transmission media includes coaxial cables, copper wire and fiber optics, including the wires that comprise bus 902. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are exemplary forms of carrier waves transporting the information.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution. In this manner, computer system 900 may obtain application code in the form of a carrier wave.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

What is claimed is:

1. A computer-implemented method comprising:
receiving a first request to verify a first requested transfer of funds from a first account to a first merchant prior to the first merchant receiving an acceptance of the first requested transfer of funds;
identifying a first instance of an application program installed on a first mobile wireless device as being associated with the first account;
causing, in response to receiving the first request, a first notification of the first requested transfer of funds to be presented on the first mobile wireless device via the first instance of the application program;
determining that the first requested transfer of funds is not approved by a user of the account based on a first message received from the first instance of the application program or a failure to receive a message from the first instance of the application program within a predetermined period of time; and
causing use of the first account to be disabled in response to the determination that the first requested transfer of funds is not approved by a user of the account.

2. The computer-implemented method of claim 1, further comprising:
notifying an issuer associated with the first account that the first requested transfer of funds is considered fraudulent.

3. The computer-implemented method of claim 2, wherein the first request is received from the issuer of the first account.

4. The computer-implemented method of claim 1, further comprising:
causing, in response to the determination that the first requested transfer of funds is not approved by a user of the account, a second notification to be presented on the first mobile wireless device via the first instance of the application, the second notification indicating that the first account has been disabled.

5. The computer-implemented method of claim 1, further comprising:
receiving a second request to verify a second requested transfer of funds from the first account to a second merchant prior to the second merchant receiving an acceptance of the second requested transfer of funds;
causing, in response to receiving the second request, a second alert of the second requested transfer of funds to be presented on the first mobile wireless device via the first instance of the application;
determining that the second requested transfer of funds is approved by a user of the account based on a second message received from the first instance of the application; and
responding to the second request with an indication that the second requested transfer of funds has been verified by a user of the account.

6. The computer-implemented method of claim 5, further comprising:
obtaining a notification address associated with the account; and
sending a notification to the notification address including details of the second requested transfer of funds.

7. The computer-implemented method of claim 1, further comprising:
receiving a second message indicating a transaction amount limit for the first instance of the application;
receiving a second request to verify a second requested transfer of funds from the first account to a second merchant prior to the second merchant receiving an acceptance of the second requested transfer of funds;
determining that an amount of the second requested transfer of funds is greater than the transaction amount limit; and
rejecting or declining the second request in response to the determination that the amount of the second requested transfer of funds is greater than the transaction amount limit.

8. The computer-implemented method of claim 1, further comprising:
receiving a second message indicating an allowed time period for use of the first account in association with the first instance of the application;
receiving a second request to verify a second requested transfer of funds from the first account to a second merchant prior to the second merchant receiving an acceptance of the second requested transfer of funds;
determining that the second requested transfer of funds has been requested outside of the allowed time period; and
rejecting or declining the second request in response to the determination that the amount of the second requested transfer of funds is greater than the transaction amount limit.

9. The computer-implemented method of claim 1, further comprising:
receiving a second message from a second instance of the application, the second message requesting the first account be enabled;
determining the second instance is associated with the first account; and
reenabling the first account in response to the second message.

10. The computer-implemented method of claim 1, further comprising:
retrieving a specification of a reoccurring charge associated with the first account;
determining that the first merchant corresponds to a merchant identified in the specification of the reoccurring charge;
determining that the first requested transfer of funds does not violate any limitations recorded in the specification of the reoccurring charge; and
approving the first request in response to the determination that the first merchant corresponds to the merchant identified in the specification of the reoccurring charge and the determination that the first requested transfer of funds does not violate any limitations recorded in the specification of the reoccurring charge.

11. A system comprising:
one or more processors; and
one or more machine readable media including instructions, which when executed by the one or more processors, cause the one or more processors to:
receive a first request to verify a first requested transfer of funds from a first account to a first merchant prior to the first merchant receiving an acceptance of the first requested transfer of funds;
identify a first instance of an application program installed on a first mobile wireless device as being associated with the first account;
cause, in response to receiving the first request, a first notification of the first requested transfer of funds to be presented on the first mobile wireless device via the first instance of the application program;
determine that the first requested transfer of funds is not approved by a user of the account based on a first message received from the first instance of the application program or a failure to receive a message from the first instance of the application program within a predetermined period of time; and
cause use of the first account to be disabled in response to the determination that the first requested transfer of funds is not approved by a user of the account.

12. The system of claim 11, wherein the instructions further cause the one or more processors to:
notify an issuer associated with the first account that the first requested transfer of funds is considered fraudulent.

13. The system of claim 12, wherein the first request is received from the issuer of the first account.

14. The system of claim 11, wherein the instructions further cause the one or more processors to:
cause, in response to the determination that the first requested transfer of funds is not approved by a user of the account, a second notification to be presented on the first mobile wireless device via the first instance of the application, the second notification indicating that the first account has been disabled.

15. The system of claim 11, wherein the instructions further cause the one or more processors to:
receive a second request to verify a second requested transfer of funds from the first account to a second merchant prior to the second merchant receiving an acceptance of the second requested transfer of funds;
cause, in response to receiving the second request, a second alert of the second requested transfer of funds to be presented on the first mobile wireless device via the first instance of the application;
determine that the second requested transfer of funds is approved by a user of the account based on a second message received from the first instance of the application; and
respond to the second request with an indication that the second requested transfer of funds has been verified by a user of the account.

16. The system of claim 15, wherein the instructions further cause the one or more processors to:
obtain a notification address associated with the account; and
send a notification to the notification address including details of the second requested transfer of funds.

17. The system of claim 11, wherein the instructions further cause the one or more processors to:
receive a second message indicating a transaction amount limit for the first instance of the application;
receive a second request to verify a second requested transfer of funds from the first account to a second merchant prior to the second merchant receiving an acceptance of the second requested transfer of funds;
determine that an amount of the second requested transfer of funds is greater than the transaction amount limit; and
reject or decline the second request in response to the determination that the amount of the second requested transfer of funds is greater than the transaction amount limit.

18. The system of claim 11, wherein the instructions further cause the one or more processors to:
receive a second message indicating an allowed time period for use of the first account in association with the first instance of the application;
receive a second request to verify a second requested transfer of funds from the first account to a second merchant prior to the second merchant receiving an acceptance of the second requested transfer of funds;
determine that the second requested transfer of funds has been requested outside of the allowed time period; and
reject or decline the second request in response to the determination that the amount of the second requested transfer of funds is greater than the transaction amount limit.

19. The system of claim 11, wherein the instructions further cause the one or more processors to:
receive a second message from a second instance of the application, the second message requesting the first account be enabled;
determine the second instance is associated with the first account; and
reenable the first account in response to the second message.

20. The system of claim 11, wherein the instructions further cause the one or more processors to:
retrieve a specification of a reoccurring charge associated with the first account;
determine that the first merchant corresponds to a merchant identified in the specification of the reoccurring charge;
determine that the first requested transfer of funds does not violate any limitations recorded in the specification of the reoccurring charge; and
approve the first request in response to the determination that the first merchant corresponds to the merchant identified in the specification of the reoccurring charge and the determination that the first requested transfer of funds does not violate any limitations recorded in the specification of the reoccurring charge.
